(19) United States
(12) Patent Application Publication
(10) Pub. No.: US 2014/0278451 A1
(43) Pub. Date: Sep. 18, 2014

(54) Integration of Diagnostic Devices into a Brokerage System

(71) Applicant: Roy Schoenberg, Boston, MA (US)

(72) Inventor: Roy Schoenberg, Boston, MA (US)

(21) Appl. No.: 13/798,378

(22) Filed: Mar. 13, 2013

(51) Int. Cl. G06Q 50/22; G06Q 10/06

(52) U.S. Cl. CPC G06Q 50/22; G06Q 10/06
USPC 705/2

(57) ABSTRACT

An apparatus comprises a diagnostic device configured to be operated by a first medical service provider to collect diagnostic data indicative of a physiological condition of a patient; and a processing device configured for communication with the diagnostic device and a brokerage system during a real-time consultation between the patient and a second medical service provider, over a real-time communication channel established by the brokerage system, with the processing device being further configured to cause the diagnostic data to be transmitted to a device used by the service provider during the real-time consultation to promote diagnosis of the physiological condition of the patient.

### BACKGROUND

The present disclosure is directed to connecting consumers with service providers.

Systems have been developed to connect consumers and their providers over the Internet and the World Wide Web. Some systems use e-mail messaging and web-based forms to increase the level of connectivity between a member of a health plan and his assigned health care provider. The consumer sends an e-mail or goes to a website that generates and sends a message (typically an e-mail or an e-mail type message) to a local provider.

These types of services have been broadly referred to as “e-visits.” While generally viewed as an addition to the spectrum of services that may be desired by consumers, the benefits of such services are not clear. One of the concerns associated with offering additional communication channels, such as e-mail, is that it can result in over consumption of services, rather than provide for better coordination.

Another system is a brokerage type of system as described in my issued U.S. Pat. No. 7,590,550, which is incorporated herein by reference.

### SUMMARY

In general, in one aspect, an apparatus includes a diagnostic device configured to be operated by a first medical service provider to collect diagnostic data indicative of a physiological condition of a patient; and a processing device configured for communication with the diagnostic device and a brokerage system during a real-time consultation between the patient and a second medical service provider, over a real-time communication channel established by the brokerage system, with the processing device being further configured to cause the diagnostic data to be transmitted to a device used by the second medical service provider during the real-time consultation to promote diagnosis of the physiological condition of the patient.

Implementations of the disclosure may include one or more of the following features. In some implementations, the processing device is further configured to: generate a message that includes the diagnostic data and an address of the device used by the second medical service provider. In other implementations, the processing device is further configured to transmit the message to the brokerage system. In still other implementations, the processing device is further configured to transmit the message directly to the device used by the second medical service provider. In some implementations, the diagnostic device comprises at least one of an examination camera, an electronic imaging device, a spirometer with a calibration syringe, an electronic stethoscope, and a microconvex probe. In still other implementations, the apparatus includes a display device configured for communication with the processing device, with the display device being further configured to use the collected diagnostic data in rendering an image of a portion of the patient's body.

In yet other implementations, the processing device is configured perform operations comprising: receiving, from the brokerage system, data indicative of instructions for the first medical service provider to reposition the diagnostic device on a portion of anatomy of the patient; collecting, over the diagnostic device, updated diagnostic data, following repositioning of the diagnostic device; and transmitting, to the brokerage system, the updated diagnostic data.

In another aspect of the disclosure, a computer-implemented method includes establishing, by a brokerage system, a communication channel between a device used by a consumer and a device used by a service provider; receiving, from the device used by the consumer, diagnostic data collected from a diagnostic device in communication with the device used by the consumer; transmitting the diagnostic data to the device used by the service provider to promote diagnosis of a physiological condition of the consumer; receiving, from the device used by the service provider, information indicative of instructions for repositioning of the diagnostic device to provide the service provider with a requested view of a portion of the consumer's body; forwarding, to the device used by the consumer of services, the information indicative of instructions for placement of the diagnostic device to provide the service provider with the requested view of the portion of the consumer's body; receiving, from the device used by the consumer of services, updated diagnostic data indicative of the requested view of the portion of the consumer's body; and transmitting, to the device used by the service provider, the updated diagnostic data as a real-time video stream.

Implementations of the disclosure may include one or more of the following features. In some implementations, transmitting the diagnostic data to the device used by the service provider comprises: streaming, to the device used by the service provider, a live video of a portion of the consumer's body as the live video is taken by diagnostic device. In other implementations, the method includes receiving, from a device used by a consumer, a request to consult with an available service provider having a service provider profile that satisfies at least some attributes in a set of attributes that define a suitable service provider. In still other implementations, the diagnostic device comprises at least one of an examination camera, an electronic imaging device, a spirometer with a calibration syringe, an electronic stethoscope, and a microconvex probe.

In another aspect of the disclosure, one or more machine-readable storage media are configured to store instructions for causing one or more processing devices to perform operations comprising: establishing a communication channel between a device used by a consumer and a device used by a service provider; receiving, from the device used by the consumer, diagnostic data collected from a diagnostic device in communication with the device used by the consumer; transmitting the diagnostic data to the device used by the service provider to promote diagnosis of a physiological condition of the consumer; receiving, from the device used by the service provider, information indicative of instructions for repositioning of the diagnostic device to provide the service provider with a requested view of a portion of the consumer's body; forwarding, to the device used by the consumer of services, the information indicative of instructions for placement of the diagnostic device to provide the service provider with the requested view of the portion of the consumer's body; receiving, from the device used by the consumer of services, updated diagnostic data indicative of the requested view of the portion of the consumer's body; and transmitting, to the device used by the service provider, the updated diagnostic data as a real-time video stream. Implementations of this aspect of the present disclosure can include one or more of the foregoing features.

In still another aspect of the disclosure, a system includes one or more processing devices; and one or more machine-readable media configured to store instructions that are executable to cause the one or more processing devices to perform operations comprising: establishing a communication channel between a device used by a consumer and a device used by a service provider; receiving, from the device used by the consumer, diagnostic data collected from a diagnostic device in communication with the device used by the consumer; transmitting the diagnostic data to the device used by the service provider to promote diagnosis of a physiological condition of the consumer; receiving, from the device used by the service provider, information indicative of instructions for repositioning of the diagnostic device to provide the service provider with a requested view of a portion of the consumer's body; forwarding, to the device used by the consumer of services, the information indicative of instructions for placement of the diagnostic device to provide the service provider with the requested view of the portion of the consumer's body; receiving, from the device used by the consumer of services, updated diagnostic data indicative of the requested view of the portion of the consumer's body; and transmitting, to the device used by the service provider, the updated diagnostic data as a real-time video stream. Implementations of this aspect of the present disclosure can include one or more of the foregoing features.

All or part of the foregoing may be implemented as a computer program product including instructions that are stored on one or more non-transitory machine-readable storage media, and that are executable on one or more processing devices. All or part of the foregoing may be implemented as an apparatus, method, or electronic system that may include one or more processing devices and memory to store executable instructions to implement the stated functions.

The details of one or more embodiments are set forth in the accompanying drawings and the description below. Other features, objects, and advantages will be apparent from the description and drawings, and from the claims.

### BRIEF DESCRIPTION OF THE FIGURES

FIG. 1 is a diagrammatic view of an engagement brokerage service for use with a diagnostic device.

FIG. 2 is a screen shot of a graphical user interface depicting visualizations of diagnostic data collected with a diagnostic device.

FIG. 3 is a diagram of a diagnostic device for use with a client device.

FIG. 4 is a flowchart of a process useful in understanding the engagement brokerage service.

FIG. 5 is a block diagram of a computer (computer system) showing exemplary components that can be used for the brokerage system and/or client systems.

### DETAILED DESCRIPTION

Overview

The system described below provides an integrated information and communication platform that enables consumers of services to identify and prioritize service providers with whom they should consult and to carry out consultations with such service providers in an efficient manner. Consumers are able to consult on-line with an expert service provider, at a mutually convenient time and place, even when the two parties are geographically separated. This integrated platform is referred to herein as an engagement brokerage service (brokerage).

FIG. 1 shows an example system 100 implementing the brokerage service. The system 100 includes a computerized system or server 110 for making connections between consumers 120, at client systems 122, and service providers 130, at client systems 132, over a network 140, e.g., the Internet or other types of networks. The computerized system 110 may operate as a service running on a web server 102.

The computerized system 110 includes an availability or presence tracking module 112 for tracking the availability of the service providers 130. Availability or presence is tracked actively or passively. In an active system, one or more of the service providers 130 provides an indication to the computerized system 110 that the one or more service providers are available to be contacted by consumers 120 and an indication of the mode by which the provider may be contacted. In some examples of an active system, the provider's computer, phone, or other terminal device periodically provides an indication of the provider's availability (e.g., available, online, idle, busy) to the system 110 and a mode (e.g., text, voice, video, etc.) by which he can be engaged. In a passive system, the computerized system 110 presumes that the service provider 130 is available by the service provider's actions, including connecting to the computerized system 110 or registering the provider's local phone number with the system. In some examples of a passive system, the system 110 indicates the provider 130 to be available at all times until the provider logs off, except when the provider is actively engaged with a consumer 120.

The computerized system 110 also includes one or more processes such as the tracking module 112 and a scheduling module 116. The system 110 accesses one or more databases 118. The components of the system 110 and the web server 102 may be integrated or distributed in various combinations as is commonly known in the art.

Using the system 100, a consumer 120 communicates with a provider 130. The consumers 120 and providers 130 connect to the computerized system 110 through a website or other interface on the web server 102 using client devices 122 and 132, respectively. Client devices 122 and 132 can be any combination of, e.g., personal digital assistants, land-line telephones, cell phones, computer systems, media-player-type devices, and so forth. The client devices 122 and 132 enable the consumers 120 to input and receive information as well as to communicate via video, audio, and/or text with the providers 130.

Limited by office hours and other patients, providers struggle with the idea of adding another service commitment to their existing workload. Patients sending queries to their providers can not expect an immediate response and are often asked to schedule an appointment for further evaluation. Providers are, however, often available at times that are not convenient for their patients, for example, in the event of a last-minute cancellation. Providers also may be available for e-visits during otherwise idle times, such as when home, during their commute, and so forth. The brokerage supplements existing provider availability to allow whichever providers are available at any given time to provide e-Visits to whichever consumers need a consultation at that time. Instead of relying on the unlikely availability of a specific provider for any given consumer, the brokerage connects the consumer to all online providers capable of addressing the consumer's needs. The brokerage has distinct features including the ability to engage in live communication, e.g., session with a suitable, selectable provider and the ability to do so on-demand.

One advantage that the brokerage provides is that the brokerage constantly monitors the availability of a provider for an engagement and thus, consumers receive immediate attention to address their questions or concerns, since the brokerage will connect them to available service providers. In order to achieve such a level of availability, the system assimilates the discretionary or fractional availability windows of time offered by individual providers into a continuous availability perception by consumers. Since many of the services offered to consumers are on-demand, consumers have little expectation that the same provider will be constantly available, rather, they expect that some provider will be available.

The computerized system 110 provides information and services to the consumers 120 in addition to connecting them with providers 130. The computerized system 110 includes an access control facility 114, which manages and controls whether a given consumer 120 may access the system 110 and what level or scope of access to the features, functions, and services the system 110 will provide.

The consumer 120 uses the system 100 to find out more information about a topic of interest or, for example, a potential medical condition. The computerized system 110 identifies service providers 130 that are available at any given moment to communicate with a consumer about a particular product, service, or related topic or subject, for example, a medical condition. The computerized system 110 facilitates communication between the consumer 120 and provider 130, enabling them to communicate, for example, via a data-network-facilitated video or voice communication channel (such as Voice over IP), land and mobile telephone network channels, and instant messaging or chat. In some examples, the availability of one or more providers 130 is tracked, and at the instant a consumer 120 desires to connect and communicate with a provider, the system 110 determines whether a provider is available. If a particular provider 130 is available, the system 110 assesses the various modes of communication that are available and connects the consumer 120 and the provider 130 through one or more common modes of communication.

The system selects a mode of communication to use based in part on the relative utility of the various modes. The preferred mode for an engagement is for both the consumer 120 and the provider 130 to use web-based consoles, as this allows each of the other modes to be used as needed. For example, consumers and providers may launch chat sessions, voice calls, or video chats from within a web-based console. A web based console also provides on-demand access to records, such as the consumer's medical history, and other information. If only one of the participants in an engagement has access to a web console, the system 110 connects that participant's console to whatever form of communication the other party has available. For example, if the consumer is on the phone and the provider is using a web browser, the system 110 may connect the consumer's phone call to a VoIP session that the provider can access through the web.

If the provider 130 is not available, the system 110 identifies other available providers 130 that would meet the consumer 120's needs. The system 110 enables the consumer 120 to send a message to the consumer's chosen provider. The consumer can also have the system 110 contact the consumer in the future when the chosen provider is available.

By way of illustration, the system 100 connects members of healthcare plans with providers of healthcare products and services. For example, the service providers 130 may be physicians, and the service consumers 120 may be patients. The service providers and service consumers may also be lawyers and clients, contractors and homeowners, or any other combination of a provider of services and a consumer of services.

The system enables the consumer to search for providers that are available at the time the consumer is searching and enables the consumer to engage a provider on a transactional basis or for a one-time consultation. A consumer is able to engage a world-renowned specialist for a consultation or second opinion, even though the specialist is located too far away from the consumer to become a regular client, patient, or consumer. The consumer can use that specialist's advice when considering services by a local service provider. For example, a patient in a suburban town with a rare condition may consult with a specialist in a distant city, and then, based on that consultation, select a local physician for treatment.

System 100 also includes diagnostic device 123, which is a device for collecting physiological data of a consumer. There are various types of diagnostic devices, including, e.g., an examination camera, an electronic imaging device, a spirometer with a calibration syringe, an electronic stethoscope, and a microconvex probe. Diagnostic device 123 is operated by a medical service provider (e.g., a nurse) 121. The medical service provider 121 assists consumer 120 in using diagnostic device 123, e.g., to promote correct use of diagnostic device 123 and/or to position diagnostic device 123 on or in consumer 120.

Client device 122 includes diagnostic device collection module 124 for collection of diagnostic data that is captured by diagnostic device 123. Diagnostic device collection module 124 transmits the diagnostic data to brokerage system 110, e.g., to assist service provider 132 is engaging in a consultation with consumer 120. Brokerage system 110 establishes a communication channel between device 132 and device 122. Over the established communication channel, consumer 120 and service provider 130 engage in a consultation. During the consultation, the service provider 130 instructs the consumer 120 to use diagnostic device 123 to provide service provider 130 with diagnostic data during the consultation. Service provider 121 assists consumer 120 in operating diagnostic device 123 and/or operates diagnostic device 123 for consumer 120. As service provider 121 operates diagnostic device 123, diagnostic device collection module 124 collects diagnostic data indicative of characteristics of the anatomy of consumer 120, e.g., in region where diagnostic device 123 is placed and/or inserted. Diagnostic device collection module 124 transmits the collected diagnostic data to brokerage system 110, which re-transmits the collected diagnostic data to client device 132.

Using client device 132, service provider 130 views the collected diagnostic data (and/or views representations of the collected diagnostic data). Service provider 130 determines that diagnostic data of a different view of the consumer's body and/or for a different area of the consumer's body would be useful to service provider 130 in treating consumer 120. Over the established communication channel, service provider 130 transmits instructions to service provider 121 for how to move diagnostic device 123 and/or for how to position diagnostic device 123 to provider service provider 130 with an additional view and/or with additional diagnostic data. For example, diagnostic device 123 may be an examination camera that is used to take real-time images of a consumer's throat. Service provider 130 wants to view images of further down the consumer's throat or a different side of the consumer's throat.

Over the established communication channel, service provider 130 instructs service provider 121 on how to position diagnostic device 123 on or in consumer 120 to provide service provider 130 with the desired view. Using the received instructions, service provider 121 re-positions diagnostic device 123 to provider service provider 130 with the desired view.

Referring to FIG. 2, brokerage system 110 generates graphical user interface 150 for display on client device 132. Graphical user interface 150 includes portion 152 for display of a representation of diagnostic data collected via diagnostic device 123. In this particular example, portion 152 displays an image of a throat of consumer 120 operated by service provider 121 positioning the diagnostic device 123, here a scope or camera within the throat of the consumer 120. Graphical user interface 150 also displays portion 154 for display of a chronological representation of a text-based communication between consumer 120 and service provider 130.

Graphical user interface 150 also displays portion 156 in which service provider 130 can input textual information to be sent to consumer 120 and/or to service provider 121. Service provider 130 enters into portion 156 instructions for the placement of diagnostic device 123 and/or instructions for how service provider 121 should move diagnostic device 123 to provide service provider 130 with a requested view.

Referring to FIG. 3, client device 122 includes a communication unit 160 in communication with each of an input device 162 and a user interface device 164. Diagnostic device 123 includes sensors 166, 168, 170, 172, 174 each configured to measure a physiological parameter of the consumer 120. The communication unit 160 communicates with the network 140 (e.g., through a dial-up connection, an Internet connection or other type of network connection). During use, the communication unit 160 receives information from the network 140 and transmits the information to the user interface device 164, where the consumer 120 receives the information. The consumer 120 responds to the information received from the user interface device 164 by sending additional information to the communication unit 160 through the input device 644 and/or the sensors 166, 168, 170, 172, 174. The communication unit 160 transmits the information from the input device 162 and/or the sensors 166, 168, 170, 172, 174 over the network 140 to brokerage system 110.

The input device 162 can be a keyboard, a mouse, a touch screen, a microphone, a scanner, a barcode reader, a still camera, and/or a video camera. In some embodiments, the consumer 120 can specify the type of input device 162 to be used during the brokered engagement with the medical service provider. For example, the consumer 120 can specify a preference to communicate with the medical service provider 130 through an electronic, text-based communication such that the keyboard is the input device 162.

The user interface device 164 can be a video display monitor, a touch screen, and/or a speaker. In some embodiments, the consumer 120 can specify the type of user interface device 164 to be used during the brokered engagement with the medical service provider.

The sensors 166, 168, 170, 172, 174 are each in communication with the communication unit 160 such that the physiological parameter measured by each sensor can be sent to the communication unit 160 for transmission to brokerage system 110 over the network 140. Each sensor 166, 168, 170, 172, 174 typically includes a measuring element configured to measure a signal representative of a physiological condition and circuits in communication with the measuring element to convert the measured signal to an electronic signal representative of the physiological condition. Each sensor 166, 168, 170, 172, 174 can also receive an electronic, real-time communication (e.g., an activation/deactivation signal) the communication unit 160. In some embodiments, the communication unit 160 receives the electronic, real-time communication over the network 140 from the brokerage system, and the communication unit 160 sends the electronic, real-time communication to the sensors 166, 168, 170, 172, 174. In certain embodiments, each sensor 166, 168, 170, 172, 174 is configured to measure a physiological parameter in response to the electronic, real-time communication received from the communication unit 160.

During use, the consumer 120 sends a request over the network 140 from the client device 122 to brokerage system 110 to consult with a medical service provider (e.g., at the client device 132). The request can be a request to consult with a medical service provider having a service provider profile that satisfies at least some attributes in a set of attributes that the consumer 120 specifies as defining a suitable service provider. Examples of attributes that the consumer 120 can specify to define a suitable service provider profile are described below.

The communication unit 160 receives an identification of an available medical service provider profile satisfying at least of some of the attributes specified in the request by the patient 620. For example, the available medical service provider profile can be provided to the consumer 120 through the user interface device 164. In some embodiments, the communication unit 160 receives identification of more than one available medical service provider profile, and the consumer 120 selects a medical service provider from the plurality of profiles.

Brokerage system 110 provides a communication channel between the client device 122 associated with the patient and the client device 132 associated with the identified medical service provider 130. During the course of a medical service engagement, the consumer 120 and or medical service provider 121 uses one or more of the sensors 166, 168, 170, 172, 174 in diagnostic device 123 to send a measurement of a physiological parameters over the communication channel. Additionally or alternatively, the communication channel can include direct communication between the client device 122 and the client device 132 over the network 140 such that the measurement of the physiological parameter can be received by the medical service provider 130 directly from the consumer 120. Such direct communication can, for example, facilitate maintenance of patient privacy.

Service provider 130 uses client device 132 to send instructions to client device 122 on how one or more of sensors 166, 168, 170, 172, 174 should be positioned to provide service provider 130 with a requested view of an area of anatomy of consumer 120, e.g., during a real-time consultation between service provider 130 and consumer 120. Service provider 121 and/or consumer 120 view the sent instructions on interface 164. Based on the displayed instructions, service provider 121 positions and rearranges diagnostic device 123 (and/or one or more of sensors 166, 168, 170, 172, 174) on an area of the body of consumer 120. Following repositioning of diagnostic device 123 (and/or one or more of sensors 166, 168, 170, 172, 174), client device 122 collects new, updated diagnostic data and transmits the diagnostic data to client device 132 and/or to brokerage system 110 for re-transmission to client device 132.

Referring to FIG. 4, brokerage system 110 implements process 180 in promoting collection of requested diagnostic data. A brokerage phase 182 matches the consumer 120 with a medical service provider 130 and provides a communication channel for an electronic, real-time communication between client device 122 used by the consumer 120 and client device 132 used by the medical service provider 130 during an engagement phase 188.

In the brokerage phase 182, brokerage system 110 receives (184) a request from the consumer 120 to engage in a medical service engagement with the medical service provider 130 having a service provider profile that satisfies at least some attributes in a set of attributes. The consumer 120 defines a suitable medical service provider by selecting a set of attributes to be possessed by a service provider. The attributes selected by the consumer 120 can include geographic location, medical specialty, professional associations, a third-party ranking, gender of the medical service provider, hospital affiliation of the medical service provider, type of engagement (e.g., text-based, sound-based, or video-based) provided by the medical service provider, and/or health insurance accepted by a suitable medical service provider.

Brokerage system 110 identifies (186) an available medical service provider (e.g., medical service provider 130) satisfying at least some of the attributes in the set of attributes specified by consumer 120. The identification of an available medical service provider can include comparing desired times specified by the consumer 120 to a schedule provided to brokerage system 110 by a medical service provider. Additionally or alternatively, the identification of an available medical service provider includes sending a request to a candidate medical service provider and receiving an acceptance from the medical service provider.

In some embodiments, brokerage system 110 identifies the types of diagnostic devices and/or sensors (e.g., any of the sensors described above) available at the client device 122 associated with consumer 120, and uses the types of identified sensors as part of identifying an available medical service provider. For example, a medical service provider can specify the types of sensors and/or diagnostic devices required for a medical service engagement. If the brokerage system 110 identifies these specified sensors and/or diagnostic devices at the client device 122 associated with the consumer 120, the brokerage system 110 can continue to consider the combination of the consumer 120 and the medical service provider 130 with respect to the other attributes specified by the patient.

In the engagement phase 188, brokerage system 110 establishes (190) a communication channel between client device 122 used by the consumer 120 and client device 132 used by the identified medical service provider 130. Over the communication channel, the consumer 120 and the service provider 130 engage in an electronic, real-time communication.

During the communication, brokerage system 110 receives (192), over the communication channel, a measurement from diagnostic device 123 and/or from one of sensors 166, 168, 170, 172, 174 of diagnostic device 123. In some embodiments, the measurements transmitted by the client device 122 associated with the consumer 120 are transmitted directly to brokerage system 110. In certain embodiments, the measurements transmitted by the client device 122 associated with the consumer 120 are transmitted directly to the client device 132 associated with the medical service provider 130 such that the medical service provider 130 can choose to transmit the measurements to brokerage system 110 (e.g., for further processing and/or analysis).

Brokerage system 110 transmits the received diagnostic data to client device 132. Service provider 130 requests an alternate and/or a different view of the consumer's anatomy. To receive the requested diagnostic data, service provider 130 uses client device 132 to send to brokerage system 110 information indicative of instructions for the repositioning of diagnostic device 123. Brokerage system 110 receives (194) the instructions to reposition the diagnostic device. In response, brokerage system 110 transmits (196) the received instructions to client device 122.

Using client device 122, consumer 120 and/or service provider 121 view the instructions. Service provider 121 repositions diagnostic device 123 and/or the sensors in accordance with the instructions. Following the repositioning, client device 122 (and/or diagnostic device collection module 124 in client device 122) collects updated diagnostic data indicative of the region of the consumer's anatomy to which diagnostic device 123 is re-positioned. Client device 122 transmits the updated diagnostic data to brokerage system 110. Brokerage system 110 receives (198) the updated diagnostic data and re-transmits the updated diagnostic data to client device 132 for display to service provider 130.

FIG. 5 is a block diagram of components 220 of the engagement brokerage system. User devices 228 can be any sort of computing device capable of taking input from a user and communicating over a network (not shown) with server 110 and/or with other client devices. For example, user device 228 can be a mobile device, a desktop computer, a laptop, a cell phone, a personal digital assistant (“PDA”), a server, an embedded computing system, a mobile device and so forth. User devices 228 include monitor 230 which render visual representations of interface 236.

Server 110 can be any of a variety of computing devices capable of receiving information, such as a server, a distributed computing system, a desktop computer, a laptop, a cell phone, a rack-mounted server, and so forth. Server 110 may be a single server or a group of servers that are at a same location or at different locations.

Server 110 can receive information from client device user device 238 via interfaces 236, including, e.g., graphical user interfaces. Interfaces 236 can be any type of interface capable of receiving information over a network, such as an Ethernet interface, a wireless networking interface, a fiber-optic networking interface, a modem, and so forth. Server 110 also includes a processor 222 and memory 224. A bus system (not shown), including, for example, a data bus and a motherboard, can be used to establish and to control data communication between the components of server 110.

Processor 222 may include one or more microprocessors. Generally, processor 222 may include any appropriate processor and/or logic that is capable of receiving and storing data, and of communicating over a network (not shown). Memory 224 can include a hard drive and a random access memory storage device, such as a dynamic random access memory, machine-readable media, or other types of non-transitory machine-readable storage devices.

Components 220 also include storage device 232, which is configured to store information collected through the brokerage system during a service provider's consultation with a consumer.

Embodiments can be implemented in digital electronic circuitry, or in computer hardware, firmware, software, or in combinations thereof. Apparatus of the invention can be implemented in a computer program product tangibly embodied or stored in a machine-readable storage device for execution by a programmable processor; and method actions can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired; and in any case, the language can be a compiled or interpreted language.

Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD_ROM disks. Any of the foregoing can be supplemented by, or incorporated in, ASICs (application-specific integrated circuits).

Other embodiments are within the scope and spirit of the description claims. For example, due to the nature of software, functions described above can be implemented using software, hardware, firmware, hardwiring, or combinations of any of these. Features implementing functions may also be physically located at various positions, including being distributed such that portions of functions are implemented at different physical locations.

What is claimed is:

1. An apparatus comprising:
a diagnostic device configured to be operated by a first medical service provider to collect diagnostic data indicative of a physiological condition of a patient; and
a processing device configured for communication with the diagnostic device and a brokerage system during a real-time consultation between the patient and a second medical service provider, over a real-time communication channel established by the brokerage system, with the processing device being further configured to cause the diagnostic data to be transmitted to a device used by the second medical service provider during the real-time consultation to promote diagnosis of the physiological condition of the patient.

2. The apparatus of claim 1, wherein the processing device is further configured to:
generate a message that includes the diagnostic data and an address of the device used by the second medical service provider.

3. The apparatus of claim 2, wherein the processing device is further configured to transmit the message to the brokerage system.

4. The apparatus of claim 2, wherein the processing device is further configured to transmit the message directly to the device used by the second medical service provider.

5. The apparatus of claim 1, wherein the diagnostic device comprises at least one of an examination camera, an electronic imaging device, a spirometer with a calibration syringe, an electronic stethoscope, and a microconvex probe.

6. The apparatus of claim 1, further comprising:
a display device configured for communication with the processing device, with the display device being further configured to use the collected diagnostic data in rendering an image of a portion of the patient's body.

7. The apparatus of claim 1, wherein the processing device is configured perform operations comprising:
receiving, from the brokerage system, data indicative of instructions for the first medical service provider to reposition the diagnostic device on a portion of anatomy of the patient;
collecting, over the diagnostic device, updated diagnostic data, following repositioning of the diagnostic device; and
transmitting, to the brokerage system, the updated diagnostic data.

8. A computer-implemented method comprising:
establishing, by a brokerage system, a communication channel between a device used by a consumer and a device used by a service provider;
receiving, from the device used by the consumer, diagnostic data collected from a diagnostic device in communication with the device used by the consumer;
transmitting the diagnostic data to the device used by the service provider to promote diagnosis of a physiological condition of the consumer;
receiving, from the device used by the service provider, information indicative of instructions for repositioning of the diagnostic device to provide the service provider with a requested view of a portion of the consumer's body;
forwarding, to the device used by the consumer of services, the information indicative of instructions for placement of the diagnostic device to provide the service provider with the requested view of the portion of the consumer's body;
receiving, from the device used by the consumer of services, updated diagnostic data indicative of the requested view of the portion of the consumer's body; and
transmitting, to the device used by the service provider, the updated diagnostic data as a real-time video stream.

9. The computer-implemented method of claim 8, wherein transmitting the diagnostic data to the device used by the service provider comprises:
streaming, to the device used by the service provider, a live video of a portion of the consumer's body as the live video is taken by diagnostic device.

10. The computer-implemented method of claim 8, further comprising:
receiving, from a device used by a consumer, a request to consult with an available service provider having a service provider profile that satisfies at least some attributes in a set of attributes that define a suitable service provider.

11. The computer-implemented method of claim 8, wherein the diagnostic device comprises at least one of an examination camera, an electronic imaging device, a spirometer with a calibration syringe, an electronic stethoscope, and a microconvex probe.

12. One or more machine-readable storage media storing instructions that are executable by one or more processing device to perform operations comprising:
establishing a communication channel between a device used by a consumer and a device used by a service provider;
receiving, from the device used by the consumer, diagnostic data collected from a diagnostic device in communication with the device used by the consumer;
transmitting the diagnostic data to the device used by the service provider to promote diagnosis of a physiological condition of the consumer;
receiving, from the device used by the service provider, information indicative of instructions for repositioning of the diagnostic device to provide the service provider with a requested view of a portion of the consumer's body;
forwarding, to the device used by the consumer of services, the information indicative of instructions for placement of the diagnostic device to provide the service provider with the requested view of the portion of the consumer's body;
receiving, from the device used by the consumer of services, updated diagnostic data indicative of the requested view of the portion of the consumer's body; and
transmitting, to the device used by the service provider, the updated diagnostic data as a real-time video stream.

13. The one or more machine-readable storage media of claim 12, wherein transmitting the diagnostic data to the device used by the service provider comprises:
streaming, to the device used by the service provider, a live video of a portion of the consumer's body as the live video is taken by diagnostic device.

14. The one or more machine-readable storage media of claim 12, wherein the operations further comprise:
receiving, from a device used by a consumer, a request to consult with an available service provider having a service provider profile that satisfies at least some attributes in a set of attributes that define a suitable service provider.

15. The one or more machine-readable storage media of claim 12, wherein the diagnostic device comprises at least one of an examination camera, an electronic imaging device, a spirometer with a calibration syringe, an electronic stethoscope, and a microconvex probe.

16. A system comprising:
one or more processing devices; and
one or more machine-readable storage media storing instructions that are executable by the one or more processing device to perform operations comprising:
establishing a communication channel between a device used by a consumer and a device used by a service provider;
receiving, from the device used by the consumer, diagnostic data collected from a diagnostic device in communication with the device used by the consumer;
transmitting the diagnostic data to the device used by the service provider to promote diagnosis of a physiological condition of the consumer;
receiving, from the device used by the service provider, information indicative of instructions for repositioning of the diagnostic device to provide the service provider with a requested view of a portion of the consumer's body;
forwarding, to the device used by the consumer of services, the information indicative of instructions for placement of the diagnostic device to provide the service provider with the requested view of the portion of the consumer's body;
receiving, from the device used by the consumer of services, updated diagnostic data indicative of the requested view of the portion of the consumer's body; and
transmitting, to the device used by the service provider, the updated diagnostic data as a real-time video stream.

17. The system of claim 16, wherein transmitting the diagnostic data to the device used by the service provider comprises:
streaming, to the device used by the service provider, a live video of a portion of the consumer's body as the live video is taken by diagnostic device.

18. The system of claim 16, wherein the operations further comprise:
receiving, from a device used by a consumer, a request to consult with an available service provider having a service provider profile that satisfies at least some attributes in a set of attributes that define a suitable service provider.

19. The system of claim 16, wherein the diagnostic device comprises at least one of an examination camera, an electronic imaging device, a spirometer with a calibration syringe, an electronic stethoscope, and a microconvex probe.
